(19) United States
(12) Patent Application Publication
(10) Pub. No.: US 2004/0023529 A1
(43) Pub. Date: Feb. 5, 2004

(54) Electrical connector with damage-resistant terminals

(76) Inventors: David Gregory Howell, Gilbert, AZ (US); Fang-Chu Liao, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/213,245

(22) Filed: Aug. 5, 2002

(51) Int. Cl. H01R 12/00

(52) U.S. Cl. 439/71

(57) ABSTRACT

An electrical connector for electrically connecting an electronic package (91) with a circuit substrate. The electrical connector includes an insulative housing (3), and a multiplicity of conductive terminals (1). The housing includes a top face (32) and a bottom face (33), and a plurality of passageways (30) defined between the top face and the bottom face. The terminals are received in the passageways, respectively. Each terminal includes a soldering base (10) for electrically connecting to the circuit substrate, and an upper contact beam (21) extending upwardly and forwardly from the soldering base. The upper contact beam includes a curved contact portion (22), and a distal end (24) extending downwardly and rearwardly from the curved contact portion. The curved contact portion is exposed above the top face of the housing for electrically connecting to the electronic package, and the distal end is located below the top face of the housing.

### BACKGROUND OF THE INVENTION

1. Field of the Invention

The present invention relates to an electrical connector for electrically connecting an electronic package such as a land grid array (LGA) chip with a circuit substrate such as a printed circuit board (PCB), and particularly to an electrical connector with terminals that are protected from damage during handling.

2. Description of the Prior Art

Land grid array (LGA) electrical connectors are used in personal computer (PC) systems to electrically connect LGA chips with PCBs. An LGA connector comprises a multiplicity of terminals arranged in a rectangular array. Each terminal has a base soldered to a PCB, and a contact portion depressed by and engaging with a corresponding contact pad of an LGA chip, whereby the chip and the PCB are electrically connected together by the connector.

A conventional terminal 1′ of an LGA electrical connector disclosed in U.S. Pat. No. 6,296,495 is shown in FIGS. 3 and 4. The terminal 1′ is stamped from a resilient metal strip. The terminal 1′ comprises a planar horizontal soldering base 10′, for soldering the terminal 1′ to a circuit pad 80′ of a PCB (not shown) and thereby electrically connecting the terminal 1′ with the PCB. An upper contact beam 21 ′ extends upwardly and forwardly from a rear end 11 ′ of the soldering base 10′. The upper contact beam 21 ′ has a free end 22′. The free end 22′ has a curved top portion for engaging with a plate-like contact pad 90′ on a bottom face of an LGA chip 91′ when the LGA chip 91′ is pressed against the LGA electrical connector. The terminal 1′ thereby electrically connects the LGA chip 91′ with the PCB. A pair of parallel anti-rotation tabs 50′ extends rearwardly from the rear end 11′ of the soldering base 10′. A lower beam 23′ upwardly and forwardly extends from a front end 13′ of the soldering base 10′. The lower beam 23′ is spaced a distance below the upper contact beam 21′, and is for supporting the terminal 1′. A vertically oriented junction portion 25′ extends from a front end of the lower beam 23′. An upper section of the junction portion 25′ is bifurcated, and forms a pair of retention arms 251′. The lower contact beam 23′ and the junction portion 25′ are integrally joined between the retention arms 251′. A plurality of barbs 252′ is respectively formed on opposite vertical side edges of the junction portion 25′, for interferentially fixing the terminal 1′ in an insulative housing 3′.

Each terminal 1′ is accommodated in a respective passageway section 30′ of the housing 3′. The soldering base 10′ is located at a bottom face 33′ of the housing 3′. The retention arms 251′ of the junction portion 25′ are held in corresponding recesses 31′ of the housing 3′. The anti-rotation tabs 50′ are retained in a corresponding anti-rotation cavity 350′ of the housing 3′. The soldering base 10′ is soldered to the circuit pad 80′ of the PCB. The contact pad 90′ of the LGA chip 91′ downwardly presses the free end 22′ of the upper contact beam 21′. Thus the terminal 1′ electrically connects the PCB to the LGA chip 91′. However, the free end 22′ needs to be positioned above a top face 32′ of the housing 3′, to facilitate pressing of the contact pad 90′ on the free end 22′. Thus the free end 22′ is prone to be damaged if a user accidentally scrapes the free end 22′ rearwardly during handling. This can cause deformation of and damage to the terminal 1′, and even failure of electrical connection between the LGA chip 91′ and the PCB.

A new LGA electrical connector that overcomes the above-mentioned disadvantages of the prior art is desired.

### SUMMARY OF THE INVENTION

Accordingly, an object of the present invention is to provide an electrical connector for electrically connecting an electronic package such as an LGA chip with a circuit substrate such as a PCB, whereby terminals of the electrical connector are protected from accidental deformation or damage during handling.

To achieve the above-mentioned object, an electrical connector in accordance with a preferred embodiment of the present invention includes an insulative housing and a plurality of conductive terminals received in the housing. The housing includes a top face and a bottom face, and a plurality of passageways defined between the top face and the bottom face. The terminals are received in the passageways, respectively. Each terminal includes a soldering base for electrically connecting to a circuit substrate, and an upper contact beam extending upwardly and forwardly from the soldering base. The upper contact beam includes a curved contact portion, and a distal end extending downwardly and rearwardly from the curved contact portion. The curved contact portion is exposed above the top face of the housing for electrically connecting to the electronic package, and the distal end is located below the top face of the housing.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a terminal of an LGA electrical connector in accordance with a preferred embodiment of the present invention;

FIG. 2 is a cross-sectional view of a passageway of part of a housing of the LGA electrical connector in accordance with the present invention, together with the terminal of FIG. 1 received therein, and also showing part of an LGA chip and a circuit pad;

FIG. 3 is an isometric view of a conventional electrical terminal; and

FIG. 4 is a cross-sectional view of a passageway of part of a housing of a conventional connector, together with the terminal of FIG. 3 received therein, and also showing part of an LGA chip and a circuit pad.

### DETAILED DESCRIPTION OF PREFERRED EMBODIMENT OF THE INVENTION

Reference will now be made to the drawings to describe the present invention in detail.

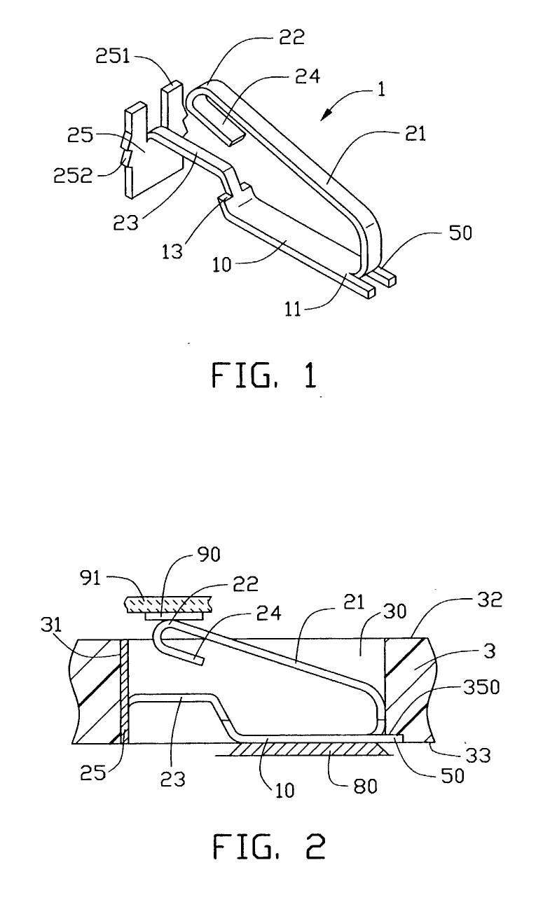

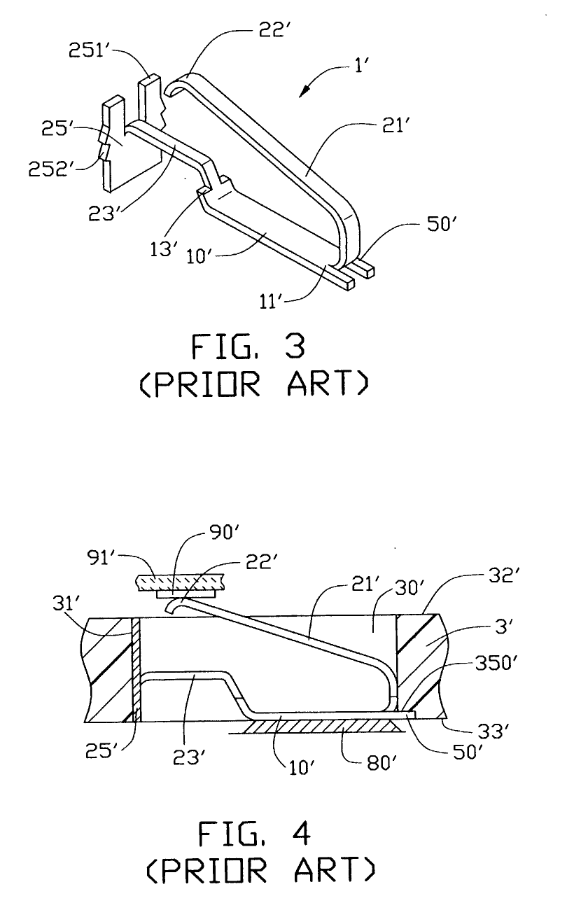

Referring to FIGS. 1 and 2, a conductive terminal 1 of an LGA electrical connector in accordance with a preferred embodiment of the present invention comprises a planar horizontal soldering base 10 for soldering the terminal 1 to a circuit pad 80 of a PCB (not shown). An upper contact beam 21 extends upwardly and forwardly from a rear end 11 of the soldering base 10. The upper contact beam 21 has a distal curved contact portion 22, for engaging with a plate-like contact pad 90 that is on a bottom face of an LGA chip 91. A distal end 24 extends downwardly and rearwardly from the curved contact portion 22. A pair of parallel anti-rotation tabs 50 extends rearwardly from the soldering base 10 at the upper contact beam 21. A lower beam 23 extends upwardly and forwardly from a front end 13 of the soldering base 10. The lower beam 23 is spaced a distance below the upper contact beam 21, and is for supporting the terminal 1. A vertically oriented junction portion 25 extends from a front end of the lower beam 23. An upper section of the junction portion 25 is bifurcated, and forms a pair of retention arms 251. The lower contact beam 23 and the junction portion 25 are integrally joined between the retention arms 251. A plurality of barbs 252 is respectively formed on opposite vertical side edges of the junction portion 25, for interferentially fixing the terminal 1 in an insulative housing 3.

Referring particularly to FIG. 2, each terminal 1 is accommodated in a respective passageway 30 of the housing 3. The upper contact beam 21 is located at a top face 32 of the housing 3, and soldering base 10 is located at a bottom face 33 of the housing 3. The retention arms 251 of the junction portion 25 are held in corresponding recesses 31 of the housing 3. The anti-rotation tabs 50 are retained in a corresponding anti-rotation cavity 350 of the housing 3. The soldering base 10 is soldered to the circuit pad 80 of the PCB. The contact pad 90 of the LGA chip 91 downwardly presses the contact portion 22 of the upper contact beam 21. Thus the terminal 1 electrically connects the PCB to the LGA chip 91. The distal end 24 of the terminal 1 is located below the top face 32 and within the passageway 30 of the housing 3. Only the curved contact portion 22 is exposed out of the passageway 30 above the top face 32. This helps prevent the distal end 24 from being accidentally scraped during handling. Thus, the risk of damage to the terminal 1 is effectively reduced.

While a preferred embodiment in accordance with the present invention has been shown and described, equivalent modifications and changes known to persons skilled in the art according to the spirit of the present invention are considered within the scope of the present invention as defined in the appended claims.

What is claimed is:

1. An electrical connector for connecting an electronic package with a circuit substrate, the electrical connector comprising:
an insulative housing comprising a top face and a bottom face, and a plurality of passageways defined between the top face and the bottom face; and
a plurality of conductive terminals received in the passageways, respectively, each of the terminals comprising a soldering base for electrically connecting to the circuit substrate, and an upper contact beam extending upwardly and forwardly from the soldering base, the upper contact beam comprising a curved contact portion and a distal end extending downwardly and rearwardly from the curved contact portion;
wherein the curved contact portion is exposed above the top face of the housing for electrically connecting to the electronic package, and the distal end is located below the top face of the housing.

2. The electrical connector as claimed in claim 1, wherein the distal end is located in a corresponding passageway of the housing.

3. The electrical connector as claimed in claim 1, wherein each of the terminals further comprises a junction portion having a pair of retention arms.

4. The electrical connector as claimed in claim 3, wherein each of the terminals further comprises a lower beam disposed between a front end of the soldering base and the junction portion, for supporting the terminal.

5. The electrical connector as claimed in claim 3, wherein the housing further defines a plurality of recesses respectively in communication with the passageways and accommodating the retention arms of the terminals.

6. The electrical connector as claimed in claim 5, wherein a plurality of barbs is formed on opposite sides of the junction portion, for interferentially engaging in corresponding recesses of the housing.

7. A land grid array electrical connector for connecting a land grid array chip with a circuit board, the land grid array electrical connector comprising:
an insulative housing having a top face and a bottom face, and a plurality of passageways defined between the top face and the bottom face; and
a plurality of terminals received in the passageways, respectively, each of the terminals having an upper contact beam, a contact portion extending from the upper contact beam for electrically connecting to the land grid array chip, and a distal end extending from the contact portion;
wherein the contact portion is positioned above the top face of the housing, and the distal end is positioned below the top face of the housing.

8. The electrical connector as claimed in claim 7, wherein the distal end is located in a corresponding passageway of the housing.

9. The electrical connector as claimed in claim 7, wherein each of the terminals further comprises a junction portion having a pair of retention arms.

10. The electrical connector as claimed in claim 9, wherein each of the terminals further comprises a soldering base and a lower beam extending between the soldering base and the junction portion, whereby the lower beam supports the terminal.

11. The electrical connector as claimed in claim 9, wherein the housing further defines a plurality of recesses respectively in communication with the passageways and accommodating the retention arms of the terminals.

12. The electrical connector as claimed in claim 11, wherein a plurality of barbs is formed on opposite sides of the junction portion, for interferentially engaging in corresponding recesses of the housing.

13. An electrical connector for use with an electrical package and a printed circuit board parallel to each other and sandwiching said connector therebetween, comprising:
an insulative housing defining upper and bottom surfaces for respectively engagement with the electrical package and the printed circuit board;
a plurality of passageways extending through the housing between said upper and bottom surfaces, each of said passageways defining a lengthwise direction and the lateral direction perpendicular to each other;
a plurality of terminals received in the corresponding passageways, respectively, each of said terminals including a vertical retention plate abutting against the housing, a lower beam integrally extending along the lengthwise direction, a solder base extending from the lower beam opposite to said vertical retention plate and generally flush with the bottom surface of the housing, an upper beam reversely upwardly extending from the solder base along said lengthwise direction, a curved contact portion extending from the upper beam and above the upper surface, and a distal end portion of the terminal extending reversely and downwardly from the curved contact portion; wherein
the distal end portion is located below the upper surface when said terminal is in a relaxed manner, and said distal end portion is not engaged with either the upper beam or the lower beam when said terminal is in a compressed manner by the electrical package.

14. The connector as claimed in claim 13, wherein said distal end portion is essentially parallel to the upper beam.

15. The connector as claimed in claim 13, wherein the lower beam is parallel to the upper and bottom surfaces.

16. The connector as claimed in claim 13, wherein said distal end portion extends downwardly along said lengthwise direction while terminated before flying over said solder base.
